(19) United States
(12) Patent Application Publication
(10) Pub. No.: US 2026/0078286 A1
(43) Pub. Date: Mar. 19, 2026

(54) ADHESIVE SHEET AND METHOD FOR MANUFACTURING ADHESIVE SHEET

(71) Applicant: LINTEC CORPORATION, Tokyo (JP)

(72) Inventors: Sho KOSABA, Tokyo (JP); Takayuki ARAI, Tokyo (JP)

(73) Assignee: LINTEC CORPORATION, Tokyo (JP)

(21) Appl. No.: 19/128,418

(22) PCT Filed: Nov. 9, 2023
(86) PCT No.: PCT/JP2023/040317

§ 371 Date: May 8, 2025

(30) Foreign Application Priority Data
Nov. 9, 2022 (JP) 2022-179910

(51) Int. Cl. C09J 11/06; C09J 7/10; C09J 7/38

(52) U.S. Cl. CPC C09J 11/06; C09J 7/10; C09J 7/385; C09J 2301/302; C09J 2301/408; C09J 2400/146

(57) ABSTRACT

A pressure sensitive adhesive sheet includes at least a pressure sensitive adhesive layer, wherein a pressure sensitive adhesive constituting the pressure sensitive adhesive layer is an emulsion-type pressure sensitive adhesive containing a cyclic oligosaccharide, and an adhesive strength to soda-lime glass is 5 N/25 mm or more. The above emulsion-type pressure sensitive adhesive is preferably an emulsion-type acrylic-based pressure sensitive adhesive.

### TECHNICAL FIELD

The present invention relates to a pressure sensitive adhesive sheet using an emulsion-type pressure sensitive adhesive and a method for manufacturing the pressure sensitive adhesive sheet.

### BACKGROUND ART

For pressure sensitive adhesive layers for various applications, organic solvent-based pressure sensitive adhesives have been commonly used. However, organic solvent-based pressure sensitive adhesives are not environmentally friendly because the organic solvent evaporates during application. For this reason, in recent years, there has been a demand to switch to water-based pressure sensitive adhesives.

For example, Patent Document 1 discloses a pressure sensitive adhesive composition that contains: an acrylic-based polymer emulsion obtained by emulsion polymerization of an emulsion containing a monomer mixture containing 80 wt. % or more of (meth)acrylic ester, a reactive emulsifier containing a radical polymerizable functional group, and a polymerization initiator; and 0.01 to 1 pt.wt. of a silane coupling agent per 100 pts.wt. of the solid content of the acrylic-based polymer emulsion.

### PRIOR ART DOCUMENTS

### Patent Documents

Patent Document 1: JP4481020B

### SUMMARY OF THE INVENTION

### Problems to be Solved by the Invention

In emulsion-type pressure sensitive adhesives, however, the ultra-high molecular-weight polymer diffuses and forms a film after coating and drying, which tends to result in a low film strength. This may cause problems with the pressure sensitive adhesive layer, such as low pressure sensitive adhesive durability and low holding power.

The present invention has been made in consideration of the actual circumstances as above, and an object of the present invention is to provide a pressure sensitive adhesive sheet with excellent pressure sensitive adhesive durability and holding power and a method for manufacturing the pressure sensitive adhesive sheet.

### Means for Solving the Problems

To achieve the above object, first, the present invention provides a pressure e sensitive adhesive sheet comprising at least a pressure sensitive adhesive layer, wherein a pressure sensitive adhesive constituting the pressure sensitive adhesive layer is an emulsion-type pressure sensitive adhesive containing a cyclic oligosaccharide, and an adhesive strength to soda-lime glass is 5 N/25 mm or more (Invention 1).

The pressure sensitive adhesive sheet according to the above invention (Invention 1) has the above composition and satisfies the above physical properties, thereby providing excellent pressure sensitive adhesive durability and holding power.

In the above invention (Invention 1), a holding power according to JIS Z0237: 2009 is preferably less than 100 μm as an amount of displacement after 70,000 seconds, wherein the amount of displacement is measured when an attachment area is 25 mm×25 mm, a test temperature is 40° C., a leaving time is 24 hours, and a load is 1 kg (Invention 2).

In the above invention (Invention 1, 2), provided that the pressure sensitive adhesive layer has a thickness of 600 μm and a width of 10 mm, a maximum stress when stretched to a breaking elongation at a measurement length of 20 mm and a tensile speed of 200 mm/min under an environment of 23° C. and 50% RH is preferably 9 N/mm² or more (Invention 3).

In the above invention or inventions (Inventions 1 to 3), provided that the pressure sensitive adhesive layer has a thickness of 600 μm and a width of 10 mm, a breaking energy when stretched to a breaking elongation at a measurement length of 20 mm and a tensile speed of 200 mm/min under an environment of 23° C. and 50% RH is preferably 30 MJ/m³ or more (Invention 4).

In the above invention or inventions (Inventions 1 to 4), the emulsion-type pressure sensitive adhesive is preferably an emulsion-type acrylic-based pressure sensitive adhesive (Invention 5).

The pressure sensitive adhesive sheet according to the above invention or inventions (Inventions 1 to 5) may comprise a base material and the pressure sensitive adhesive layer or may also comprise: two release sheets; and the pressure sensitive adhesive layer interposed between the two release sheets so as to be in contact with release surfaces of the two release sheets (Invention 6, 7).

Second, the present invention provides a method for manufacturing the pressure sensitive adhesive sheet (Invention 5), comprising: subjecting an acrylic-based monomer containing an alkyl (meth)acrylate ester to emulsion polymerization under a presence of an emulsifier to manufacture an emulsion-type (meth)acrylate polymer; preparing an emulsion-type acrylic-based pressure sensitive adhesive containing the emulsion-type (meth)acrylate polymer and a cyclic oligosaccharide; and applying the emulsion-type acrylic-based pressure sensitive adhesive to form the pressure sensitive adhesive layer (Invention 8).

In the above invention (Invention 8), an average particle diameter of the emulsion-type (meth)acrylate polymer is preferably 50 nm or more and 300 nm or less (Invention 9).

### Advantageous Effect of the Invention

The pressure sensitive adhesive sheet according to the present invention is excellent in the pressure sensitive adhesive durability and holding power. Moreover, according to the method for manufacturing a pressure sensitive adhesive sheet of the present invention, a pressure sensitive adhesive sheet excellent having pressure sensitive adhesive durability and holding power can be manufactured.

### BRIEF DESCRIPTION OF THE DRAWINGS

FIG. 1 is a cross-sectional view of a pressure sensitive adhesive sheet according to an embodiment of the present invention.

FIG. 2 is a cross-sectional view of a pressure sensitive adhesive sheet according to another embodiment of the present invention.

### EMBODIMENTS FOR CARRYING OUT THE INVENTION

Hereinafter, one or more embodiments of the present invention will be described.

The pressure sensitive adhesive sheet according to an embodiment of the present invention includes at least a and the pressure 15 pressure sensitive adhesive layer, sensitive adhesive constituting the pressure sensitive adhesive layer is an emulsion-type pressure sensitive adhesive containing a cyclic oligosaccharide. The adhesive strength of the pressure sensitive adhesive sheet according to the present embodiment to soda-lime glass is preferably 5 N/25 mm or more.

The pressure sensitive adhesive sheet according to the present embodiment has the above composition and satisfies the above physical properties, thereby providing excellent pressure sensitive adhesive durability and holding power. The above pressure sensitive adhesive durability can be evaluated by a peeling test of the testing example as an example, which will be described later. In addition, the adhesive strength in the present specification basically refers to a peel strength that is measured using a method of 180° peeling according to JIS Z0237: 2009, and the specific testing method is as described in the testing example, which will be described later.

From the viewpoint of the pressure sensitive adhesive durability and holding power, the adhesive strength of the pressure sensitive adhesive sheet according to the present embodiment to soda-lime glass is preferably more than 5 N/25 mm, particularly preferably 6 N/25 mm or more, and further preferably 7 N/25 mm or more. The upper limit of the above adhesive strength is not particularly limited, but reworkability may be required. From such a viewpoint, the above adhesive strength is preferably 100 N/25 mm or less, more preferably 50 N/25 mm or less, particularly preferably 30 N/25 mm or less, and further preferably 20 N/25 mm or less.

The above holding power is preferably less than 100 μm as an amount of displacement after 70,000 seconds, more preferably 90 μm or less, particularly preferably 80 μm or less, and further preferably 700 μm or less. The amount of displacement after 70,000 seconds is measured when an attachment area is 25 mm×25 mm, a test temperature is 40° C., a leaving time is 24 hours, and a load is 1 kg. The pressure sensitive adhesive sheet according to the present embodiment has the above composition and physical properties and can thereby achieve such a small amount of displacement and excellent holding power. The lower limit of the above holding power (amount of displacement) is most preferably 0 μm, but from the viewpoint that both the above pressure sensitive adhesive durability and holding power may readily be achieved, it is preferably 8 μm or more, more preferably 16 μm or more, particularly preferably 24 μm or more, and further preferably 32 μm or more. The specific testing method for holding power in the present specification is as described in the testing example, which will be described later.

Provided that the pressure sensitive adhesive layer of the pressure sensitive adhesive sheet according to the present embodiment has a thickness of 600 μm and a width of mm, the maximum stress when stretched to a breaking elongation at a measurement length of 20 mm and a tensile speed of 200 mm/min under an environment of 23° C. and 50% RH is preferably 9 N/mm² or more. From the viewpoints of further improving the pressure sensitive adhesive durability and holding power and readily achieving both, the above maximum stress is preferably 10 to 100 N/mm², more preferably 11 to 60 N/mm², particularly preferably 13 to 30 N/mm², and further preferably 14 to 20 N/mm².

Provided that the pressure sensitive adhesive layer of the pressure sensitive adhesive sheet according to the present embodiment has a thickness of 600 μm and a width of 10 mm, the breaking energy when stretched to a breaking elongation at a measurement length of 20 mm and a tensile speed of 200 mm/min under an environment of 23° C. and 50% RH is preferably 30 MJ/m³ or more. From the viewpoints of further improving the pressure sensitive adhesive durability and holding power and readily achieving both, the breaking energy is preferably 40 to 500 MJ/m³, more preferably 50 to 300 MJ/m³, particularly preferably 55 to 200 MJ/m³, and further preferably 60 to 150 MJ/m³.

Provided that the pressure sensitive adhesive layer of the pressure sensitive adhesive sheet according to the present embodiment has a thickness of 600 μm and a width of 10 mm, the tensile elastic modulus when subjected to a tensile test at a measurement length of 20 mm and a tensile speed of 200 mm/min under an environment of 23° C. and 50% RH is preferably 0.1 to 20 MPa, more preferably 0.3 to 16 MPa, particularly preferably 0.5 to 14 MPa, and further preferably 0.6 to 12 MPa. This allows the above pressure sensitive adhesive durability and holding power to be further excellent. Details of the tensile test in the present specification are as described in the testing example, which will be described later.

As described above, the pressure sensitive adhesive constituting the pressure sensitive adhesive layer of the pressure sensitive adhesive sheet according to the present embodiment is an emulsion-type pressure sensitive adhesive containing a cyclic oligosaccharide. Examples of emulsion-type pressure sensitive adhesives include emulsion-type acrylic-based pressure sensitive adhesives, emulsion-type rubber-based pressure sensitive adhesives, and emulsion-type urethane-based pressure sensitive adhesives. From the viewpoint of the pressure sensitive adhesive durability and holding power, emulsion-type acrylic-based pressure sensitive adhesives are preferred. Emulsion-type acrylic-based pressure sensitive adhesives will be mainly described below, but the present invention is not limited to this.

In the present embodiment, the emulsion-type acrylic-based pressure sensitive adhesive preferably contains an emulsion-type (meth)acrylate polymer (A) and a cyclic oligosaccharide (B). As used in the present specification, the term “polymer” encompasses the concept of a “copolymer.”

### 1. Each Component

### (1) Emulsion-Type (Meth)Acrylate Polymer (A)

The emulsion-type (meth)acrylate polymer (A) is a pressure sensitive adhesive base agent of the emulsion-type acrylic-based pressure sensitive adhesive. The emulsion-type (meth)acrylate polymer (A) can be obtained by an ordinary method. Preferably, it can be obtained by emulsion polymerization of an acrylic-based monomer containing an alkyl (meth)acrylate ester, and a specific method will be described later. As used in the present specification, the term “(meth)acrylic acid” refers to both the acrylic acid and the methacrylic acid. The same applies to other similar terms. The alkyl group may be linear or branched.

From the viewpoint of the pressure sensitive adhesive properties, alkyl (meth)acrylate ester whose carbon number of alkyl group is 1 to 20 is preferred as the alkyl (meth)acrylate ester. Examples of the alkyl (meth)acrylate ester whose carbon number of alkyl group is 1 to 20 include methyl (meth)acrylate, ethyl (meth)acrylate, propyl (meth)acrylate, n-butyl (meth)acrylate, n-pentyl (meth)acrylate, n-hexyl (meth)acrylate, 2-ethylhexyl (meth)acrylate, isooctyl (meth)acrylate, n-decyl (meth)acrylate, n-dodecyl (meth)acrylate, myristyl (meth)acrylate, palmityl (meth)acrylate, and stearyl (meth)acrylate.

Among the above, from the viewpoint of efficiently imparting the adhesive strength, alkyl (meth)acrylate ester whose carbon number of alkyl group is 2 to 12 is more preferred, and alkyl acrylate ester whose carbon number of alkyl group is 1 to 10 is particularly preferred.

Specifically, preferred examples include methyl (meth)acrylate, n-butyl (methacrylate, and 2-ethylhexyl (meth)acrylate, more preferred examples include n-butyl acrylate and 2-ethylhexyl acrylate, and particularly preferred examples include 2-ethylhexyl acrylate. These may each be used alone or two or more types may also be used in combination.

It is preferred to use, as the alkyl (meth)acrylate ester, a monomer whose homopolymer glass-transition temperature (Tg) exceeds 0° C. (which may be referred to as a “high Tg alkyl acrylate,” hereinafter) in combination with another alkyl (meth)acrylate ester. This can impart the desired cohesive strength to the obtained pressure sensitive adhesive.

Examples of the high Tg alkyl acrylate include methyl acrylate (Tg 10° C.), methyl methacrylate (Tg 105° C.), ethyl methacrylate (Tg 65° C.), n-butyl methacrylate (Tg 20° C.), isobutyl methacrylate (Tg 48° C.), t-butyl methacrylate (Tg 107° C.), n-stearyl acrylate (Tg 30° C.), and n-stearyl methacrylate (Tg 38° C.), among which methyl methacrylate is preferred.

The alkyl (meth)acrylate ester is preferably contained in an amount of 40 to 99.9 mass %, more preferably 55 to 99 mass %, particularly preferably 70 to 98 mass %, and further preferably 80 to 97 mass % as a monomer unit constituting the emulsion-type (meth)acrylate polymer (A).

The high Tg alkyl acrylate is preferably contained in an amount of 1 to 40 mass %, more preferably 5 to 30 mass %, particularly preferably 8 to 24 mass %, and further preferably 12 to 18 mass % as a monomer unit constituting the emulsion-type (meth)acrylate polymer (A).

In addition to the above alkyl (meth)acrylate ester, a functional group-containing monomer having a functional group in the molecule is preferably used as the acrylic-based monomer for obtaining the emulsion-type (meth)acrylate polymer (A). By containing this functional group-containing monomer, the obtained emulsion-type (meth)acrylate polymer (A) maintains independent particles in water due to the action of the functional group and has excellent dispersibility in water.

Preferred examples of functional group-containing monomers include a monomer having a hydroxyl group in the molecule (hydroxyl group-containing monomer), a monomer having a carboxy group in the molecule (carboxy group-containing monomer), and a monomer having an amino group in the molecule (amino group-containing monomer). These functional group-containing monomers may each be used alone or two or more types may also be used in combination.

Among the above functional group-containing monomers, hydroxyl group-containing monomers or carboxyl group-containing monomers are preferred from the viewpoint of dispersibility in water, and carboxyl group-containing monomers are particularly preferred.

Examples of carboxyl group-containing monomers include ethylenically unsaturated carboxylic acids such as acrylic acid, methacrylic acid, crotonic acid, maleic acid, itaconic acid, and citraconic acid. Among these, acrylic acid or methacrylic acid is preferred from the viewpoint of dispersibility in water. These may each be used alone or two or more types may also be used in combination. In particular, it is preferred to use acrylic acid and methacrylic acid in combination.

The functional group-containing monomer is preferably contained in an amount of 0.1 to 20 mass %, more preferably 1 to 15 mass %, particularly preferably 2 to 10 mass %, and further preferably 3 to 6 mass % as a monomer unit constituting the emulsion-type (meth)acrylate polymer (A).

When acrylic acid and methacrylic acid are used in combination, the compounding ratio (by mass) is preferably 99:1 to 1:99, more preferably 90:10 to 10:90, particularly preferably 80:20 to 20:80, and further preferably 70:30 to 30:70.

The average particle diameter (D50) of the emulsion-type (meth)acrylate polymer (A) is preferably 50 to 300 nm, more preferably 80 to 250 nm, particularly preferably 100 to 200 nm, and further preferably 120 to 180 nm. When the lower limit of the average particle diameter (D50) is as above, the viscosity of the coating solution of the pressure sensitive adhesive is prevented from becoming unduly high, and excellent coating suitability can be obtained. In addition, since a large amount of emulsifier is not required, a decrease in the durability of the pressure sensitive adhesive can be prevented. On the other hand, when the upper limit of the average particle diameter (D50) is as above, the sensitive pressure adhesive layer exhibits more excellent interfacial adhesion. Moreover, the average particle diameter (D50) within the above range allows the obtained pressure sensitive adhesive to exhibit more excellent cohesive strength. In the present specification, the average particle diameter (D50) is a value measured by a dynamic light scattering method.

The content of the emulsion-type (meth)acrylate polymer (A) in the emulsion-type acrylic-based pressure sensitive adhesive is preferably 60 to 99 mass %, more preferably 70 to 97 mass %, particularly preferably 80 to 96 mass %, and further preferably 90 to 95 mass %.

### (2) Cyclic Oligosaccharide (B)

The cyclic oligosaccharide (B) is usually water-soluble and therefore has excellent compatibility with water-based emulsion-type (meth)acrylate polymer (A). The haze value of the obtained pressure sensitive adhesive layer can therefore be suppressed low. On the other hand, the cyclic oligosaccharide (B) has low compatibility with solvent-based (meth)acrylate polymers, and therefore when it is compounded with a solvent-based (meth)acrylate polymer, it becomes impossible to be applied, or even when it can be applied, the haze value of the pressure sensitive adhesive layer formed will be considerably high.

The cyclic oligosaccharide (B) has the property of being able to encapsulate other compounds or linear molecules due to its cyclic shape and polarity. In the present embodiment, however, due to the rotation radius of the emulsion-type (meth)acrylate polymer (A), it is estimated that the emulsion-type (meth)acrylate polymer (A) does not penetrate the cyclic oligosaccharide (B), that is, the cyclic oligosaccharide (B) does not encapsulate the emulsion-type (meth)acrylate polymer (A). Nevertheless, the pressure sensitive adhesive layer in the present embodiment is excellent in the pressure sensitive adhesive durability and holding power.

Preferred examples of the cyclic oligosaccharide (B) include cyclodextrin and cyclodextran. One type of the cyclic oligosaccharide (B) may be used alone or two or more types may also be used in combination.

Examples of cyclodextrins include α-cyclodextrin, β-cyclodextrin, and γ-cyclodextrin, among which α-cyclodextrin or γ-cyclodextrin is preferred.

Cyclodextran is a cyclic oligosaccharide with glucose α-1,6 bonds. The number of glucoses constituting the ring of cyclodextran is preferably 5 to 15, more preferably 6 to 13, and further preferably 7 to 12.

The cyclic oligosaccharide (B) (cyclodextrin, cyclodextran) usually has hydroxyl groups, but some or all of these hydroxyl groups may be substituted with other functional groups or may be modified. The cyclic oligosaccharide (B) may also have hydroxyl groups introduced as substituents.

The content of the cyclic oligosaccharide (B) in the emulsion-type acrylic-based pressure sensitive adhesive is preferably 0.1 to 40 mass parts, more preferably 1 to 30 mass parts, particularly preferably 3 to 20 mass parts, and further preferably 5 to 10 mass parts with respect to 100 mass parts of the emulsion-type (meth)acrylate polymer (A). This allows the pressure sensitive adhesive durability and holding power to be more excellent.

### (3) Various Additives

If desired, the pressure sensitive adhesive P can contain one or more of various additives, such as silane coupling agents, ultraviolet absorbers, infrared absorbers, antistatic agents, colorants, tackifiers, antioxidants, light stabilizers, softeners, fillers, refractive index adjusters, and rust inhibitors.

In the present embodiment, it is preferred not to add a crosslinker (thermal crosslinker) such as an isocyanate-based crosslinker or an epoxy-based crosslinker. Adding a crosslinker may significantly reduce the adhesive strength.

Even if a crosslinker is added, the amount added is preferably 0.1 mass parts or less, particularly preferably 0.05 mass parts or less, and further preferably 0.01 mass parts or less with respect to 100 mass parts of the emulsion-type (meth)acrylate polymer (A).

In the present embodiment, even when a crosslinker is not added to the emulsion-type (meth)acrylate polymer (A), by adding the cyclic oligosaccharide (B), it is possible to improve the pressure sensitive adhesive durability without reducing the adhesive strength.

### 2. Preparation of Emulsion-Type Acrylic-Based Pressure Sensitive Adhesive

To prepare the emulsion-type acrylic-based pressure sensitive adhesive in the present embodiment, first, the emulsion-type (meth)acrylate polymer (A) is manufactured by an emulsion polymerization method. Specifically, the emulsion-type (meth)acrylate polymer (A) is manufactured by emulsion polymerization of the acrylic-based monomer containing the aforementioned alkyl (meth)acrylate ester under the presence of an emulsifier. Preferably, the acrylic-based monomer containing the aforementioned alkyl (meth)acrylate ester and the emulsifier are stirred and mixed in water and heated to obtain an emulsion, and then a polymerization initiator is added and emulsion polymerization is carried out by radical polymerization while heating.

Preferably, reactive emulsifiers having radical polymerizable functional groups such as propenyl groups and allyl ether groups introduced into the molecule are used as emulsifiers, and examples of such emulsifiers include anionic reactive emulsifiers and nonionic reactive emulsifiers. One type of emulsifier may be used alone or two or more types may also be used in combination.

Examples of anionic reactive emulsifiers include polyoxyethylene allyloxymethyl alkyl ether sulfate, polyoxyalkylene alkenyl ether sulfate, alkyl allyl sulfosuccinate, methacryloyloxy polyoxypropylene sulfate, polyoxyethylene alkyl propenyl phenyl ether sulfate, polyoxyethylene styrenated propenyl phenyl ether sulfate, and bis(polyoxyethylene polycyclic phenyl ether) methacrylate sulfate. Among the above, polyoxyalkylene alkenyl ether sulfate is preferred, and polyoxyalkylene alkenyl ether ammonium sulfate is particularly preferred.

Examples of nonionic reactive emulsifiers include polyoxyethylene allyloxymethyl alkyl ether, polyoxyalkylene alkenyl ether, polyoxyethylene alkyl propenyl phenyl ether, and polyoxyalkylene alkyl phenyl ether (meth)acrylate.

The amount of emulsifier added is preferably 0.1 to 10 mass parts, particularly preferably 0.5 to 5 mass parts, and further preferably 1 to 3 mass parts with respect to 100 mass parts of the total amount of acrylic-based monomers.

The above polymerization initiator is preferably a water-soluble polymerization initiator and particularly preferably a water-soluble thermal polymerization initiator. Examples of water-soluble thermal polymerization initiators include persulfates such as potassium persulfate and ammonium persulfate, peroxides such as benzoyl peroxide and laurium peroxide, and azo compounds such as azobisisobutyronitrile. These may each be used alone or two or more types may also be used in combination.

The amount of polymerization initiator added is preferably 0.1 to 2 mass parts, particularly preferably 0.2 to 1 mass part, and further preferably 0.3 to 0.5 mass parts with respect to 100 mass parts of the total amount of acrylic-based monomers.

The temperature for heating during emulsion preparation and polymerization is preferably 50° C. to 120° C. and particularly preferably 60° C. to 90° C. The time for polymerization is preferably 0.5 to 8 hours and particularly preferably 1 to 4 hours.

After the emulsion-type (meth)acrylate polymer (A) is obtained, the cyclic oligosaccharide (B), optional additives, and water can be added and sufficiently mixed to obtain a water-based emulsion-type acrylic-based pressure sensitive adhesive (coating solution).

The concentration/viscosity of the coating solution thus prepared is not particularly limited and can be appropriately selected depending on the situation, provided that the concentration/viscosity falls within any range in which the coating is possible. For example, the emulsion-type acrylic-based pressure sensitive adhesive is diluted with water to a concentration of 10 to 60 mass %.

The gel fraction of the pressure sensitive adhesive constituting the pressure sensitive adhesive layer of the pressure sensitive adhesive sheet according to the present embodiment, particularly the gel fraction of the emulsion-type acrylic-based pressure sensitive adhesive, is preferably 50% to 99%, more preferably 55% to 95%, particularly preferably 60% to 90%, further preferably 65% to 84%, and especially preferably 70% to 79%. This allows the pressure sensitive adhesive durability and holding power to be further excellent.

### 3. Configuration of Pressure Sensitive Adhesive Sheet

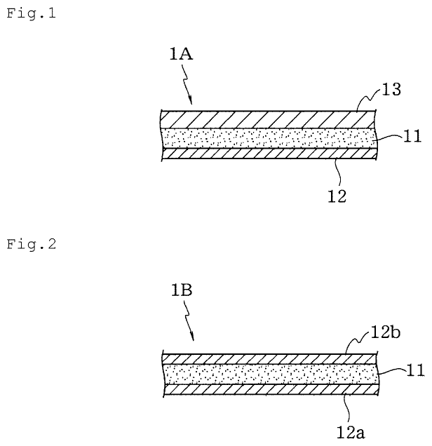

The pressure sensitive adhesive sheet according to the present embodiment includes at least a pressure sensitive adhesive layer and is preferably configured such that a release sheet is laminated on one surface or each of both surfaces of the pressure sensitive adhesive layer. A specific configuration as an example of the pressure sensitive adhesive sheet according to the present embodiment is illustrated in each of FIGS. 1 and 2.

As illustrated in FIG. 1, a pressure sensitive adhesive sheet 1A according to a first embodiment is composed of, from the bottom, a release sheet 12, a pressure sensitive adhesive layer 11 laminated on the release surface of the release sheet 12, and a base material 13 laminated on the pressure sensitive adhesive layer 11.

As illustrated in FIG. 2, a pressure sensitive adhesive sheet 1B according to a second embodiment is composed of two release sheets 12a and 12b and a pressure sensitive adhesive layer 11 that is interposed between the two release sheets 12a and 12b so as to be in contact with release surfaces of the two release sheets 12a and 12b. As used in the present specification, the release surface of a release sheet refers to a surface having releasability in the release sheet, and examples of the release surface include both a surface subjected to release treatment and a surface that exhibits releasability even without being subjected to release treatment.

In both the pressure sensitive adhesive sheets 1A and 1B, the pressure sensitive adhesive layer 11 is composed of the aforementioned emulsion-type pressure sensitive adhesive, preferably an emulsion-type acrylic-based pressure sensitive adhesive. This pressure sensitive adhesive layer 11 is preferably formed by applying a coating solution of the emulsion-type pressure sensitive adhesive to the desired object and then drying it. Drying is preferably performed by a heat treatment.

The heating temperature for the heat treatment is preferably 50° C. to 150° C. and particularly preferably 70° C. to 120° C. The heating time is preferably 10 seconds to 10 minutes and particularly preferably 50 seconds to 2 minutes.

The thickness of the pressure sensitive adhesive layer 11 (measured according to JIS K7130) is determined appropriately depending on the intended use of the pressure sensitive adhesive sheet 1A, 1B, but is usually preferably 1 to 2,000 μm, more preferably 5 to 1,000 μm, particularly preferably 10 to 500 μm, further preferably 20 to 100 μm, and especially preferably 25 to 50 μm.

The base material 13 is not particularly limited, and any base material that is used as a base material sheet for an ordinary pressure sensitive adhesive sheet can be used. Examples thereof include polyester films such as those of polyethylene terephthalate, polybutylene terephthalate, and polyethylene naphthalate, polyolefin films such as polyethylene films and polypropylene films, cellophane, diacetyl cellulose films, triacetyl cellulose films, acetyl cellulose butyrate films, polyvinyl chloride films, polyvinylidene chloride films, polyvinyl alcohol films, ethylene-vinyl acetate copolymer films, polystyrene films, polycarbonate films, polymethylpentene films, polysulfone films, polyether ether ketone films, polyether sulfone films, polyether imide films, fluororesin films, polyamide films, acrylic resin films, polyurethane resin films, norbornene-based polymer films, cyclic olefin-based polymer films, cyclic conjugated diene-based polymer films, vinyl alicyclic hydrocarbon polymer films, and other plastic films or laminated films thereof; woven or nonwoven fabrics using fibers such as those of rayon, acrylic, and polyester; papers such as high-quality paper, glassine paper, impregnated paper, and coated paper; metal foils such as those of aluminum and copper; foams such as urethane foam and polyethylene foam; and laminates of two or more of these.

The base material 13 may be a desired optical member. Examples of optical members include polarizing plates (polarizing films), polarizers, retardation plates (retardation films), viewing angle compensation films, brightness enhancement films, contrast enhancement films, liquid crystal polymer films, diffusion films, and semi-transmissive reflective films.

The thickness of the base material 13 varies depending on the type and use application, but is usually preferably 10 to 300 μm, particularly preferably 30 to 200 μm, and further preferably 50 to 150 μm.

The release sheets 12, 12a, and 12b are to protect the pressure sensitive adhesive layer 13 until the use of the pressure sensitive adhesive sheet 1 and are removed when using the pressure sensitive adhesive sheet 1 (pressure sensitive adhesive layer 11).

Examples of the release sheets 12, 12a, and 12b for use include polyethylene films, polypropylene films, polybutene films, polybutadiene films, polymethylpentene films, polyvinyl chloride films, vinyl chloride copolymer films, polyethylene terephthalate films, polyethylene naphthalate films, polybutylene terephthalate films, polyurethane films, ethylene vinyl acetate films, ionomer resin films, ethylene-(meth)acrylic acid copolymer films, ethylene-(meth)acrylic ester copolymer films, polystyrene films, polycarbonate films, polyimide films, and fluorine resin films. Crosslinked films thereof may also be used. Laminate films each obtained by laminating a plurality of such films may also be used.

It is preferred to perform release treatment for the release surfaces (in particular, surfaces to be in contact with the pressure sensitive adhesive layer 11) of the release sheets 12, 12a, and 12b. Examples of a release agent to be used for the release treatment include alkyd-based, silicone-based, fluorine-based, unsaturated polyester-based, polyolefin-based, and wax-based release agents. Preferably, one of the release sheets 12a and 12b is an easy release sheet with a large release force while the other is a tight release sheet with a small release force.

The thickness of the release sheets 12, 12a, and 12b is not particularly limited, but is usually about 20 to 150 μm.

To manufacture the above pressure sensitive adhesive sheet 1A, a coating solution of the above emulsion-type pressure sensitive adhesive is applied to the release surface of the release sheet 12, heat treatment is performed to form the pressure sensitive adhesive layer 11, and then the base material 13 is laminated on the pressure sensitive adhesive layer 11. The heat treatment conditions are as described previously.

To manufacture the pressure sensitive adhesive sheet 1B, a coating solution of the emulsion-type pressure sensitive adhesive is applied to the release surface of one release sheet 12a (or 12b), heat treatment is performed to form the pressure sensitive adhesive layer 11, and then the release surface of the other release sheet 12b (or 12a) is overlapped on the pressure sensitive adhesive layer 11.

Examples of the method of applying the above coating solution include a bar coating method, a knife coating method, a roll coating method, a blade coating method, a die coating method, and a gravure coating method.

### 4. Physical Properties

### (1) Haze Value

The haze value of the pressure sensitive adhesive layer of the pressure sensitive adhesive sheet according to the present embodiment is preferably 10% or less, preferably 5% or less, more preferably 2% or less, particularly preferably 1% or less, further preferably 0.5% or less, and especially preferably 0.3% or less. This results in high transparency and suitable use for optical applications (e.g., for display bodies). In the present embodiment, the water-soluble cyclic oligosaccharide (B) is compounded with the water-based emulsion-type (meth)acrylate polymer (A), so the compatibility is excellent and the low haze value can be achieved as described above. The lower limit of the haze value of the pressure sensitive adhesive layer is most preferably 0%, but may be 0.1% or more. The haze value in the present specification is a value measured according to JIS K7136: 2000.

### (2) Total Luminous Transmittance

The total luminous transmittance of the pressure sensitive adhesive layer of the pressure sensitive adhesive sheet according to the present embodiment is preferably 70% or more, more preferably 80% or more, particularly preferably 85% or more, and further preferably 90% or more. This results in very high transparency and suitable use for optical applications (e.g., for display bodies). The upper limit of the above total luminous transmittance of the pressure sensitive adhesive layer is most preferably 100%, but is preferably 99% or less, particularly preferably 95% or less, and further preferably 92% or less. The total luminous transmittance in the present specification is a value measured according to JIS K7361-1:1997.

### (3) CIE 1976 L*a*b* Color System

The chromaticity a* of the pressure sensitive adhesive layer of the pressure sensitive adhesive sheet according to the present embodiment, as defined by the CIE 1976 L*a*b* color system, is preferably −10 to 10, more preferably −5 to 5, particularly preferably −1 to 1, and further preferably −0.3 to 0.3. By having the chromaticity a* within the above range, the pressure sensitive adhesive layer has little color shade and is particularly suitable for optical applications (e.g., for display bodies).

The chromaticity b* of the pressure sensitive adhesive layer of the pressure sensitive adhesive sheet according to the present embodiment, as defined by the CIE 1976 L*a*b* color system, is preferably −10 to 10, more preferably −5 to 5, particularly preferably −1 to 1, and further preferably −0.6 to 0.6. By having the chromaticity b* within the above range, the pressure sensitive adhesive layer has less color shade and is suitable for optical applications (e.g., for display bodies). The method for measuring the chromaticity a* and b* defined by the CIE 1976 L*a*b* color system in the present specification is as described in the testing example, which will be described later.

It should be appreciated that the aforementioned embodiments are described to facilitate understanding of the present invention and are not described to limit the present invention. It is therefore intended that the elements disclosed in the above embodiments include all design changes and equivalents to fall within the technical scope of the present invention.

For example, the release sheet 12 in the pressure sensitive adhesive layer 1A may be omitted, and either one of the release sheets 12a and 12b in the pressure sensitive adhesive sheet 1B may also be omitted.

In the present specification, unless otherwise specified, the statement of “X to Y” (X and Y are arbitrary numbers) encompasses not only the meaning of “X or more and Y or less” but also the meaning of “preferably more than X” or “preferably less than Y.” In addition, unless otherwise specified, the statement of “X or more” (X is an arbitrary number) encompasses the meaning of “preferably more than X,” and the statement of “Y or less” (Y is an arbitrary number) encompasses the meaning of “preferably less than Y.”

### EXAMPLES

Hereinafter, the present invention will be described further specifically with reference to examples, etc., but the scope of the present invention is not limited to these examples, etc.

### Example 1

### (1) Manufacture of Emulsion-Type (Meth)Acrylate Polymer

To a four-neck flask equipped with a nitrogen gas inlet tube, a thermometer, a reflux condenser, and a stirrer, 82 mass parts of 2-ethylhexyl acrylate, 15 mass parts of methyl methacrylate, 2 mass parts of methacrylic acid, 1 mass part of acrylic acid, 1 mass part of polyoxyalkylene alkenyl ether ammonium sulfate (available from Kao Corporation, product name “LATEMUL PD-104”) as a reactive emulsifier, and 80 mass parts of distilled water, and the mixture was sufficiently stirred and heated to 70° C. After that, 0.3 mass parts of potassium persulfate as a polymerization initiator was added, and emulsion polymerization was carried out at 70° C. for 3 hours to manufacture an emulsion-type (meth)acrylate polymer.

The particle size distribution of the above emulsion-type (meth)acrylate polymer was measured by a dynamic light scattering method using a dynamic light scattering particle size distribution measuring device (available from MicrotracBEL Corp., product name “Nanotrac Wave”), and as a result the average particle diameter (D50) was 150 nm.

### (2) Preparation of Emulsion-Type Acrylic-Based Pressure Sensitive Adhesive

The coating solution of an emulsion-type acrylic-based pressure sensitive adhesive was obtained through mixing and sufficiently stirring 100 mass parts (solid content equivalent, here and hereinafter) of the emulsion-type (meth)acrylate polymer obtained in step (1) and 5 mass parts of α-cyclodextrin (α-CD) in water.

Here, Table 1 lists the formulations (solid content equivalents) of the pressure sensitive adhesives when the (meth)acrylate polymer is 100 mass parts (solid content equivalent). Details of the simplified names listed in Table 1 and additional information are as follows.

### «(Meth)Acrylate Polymer»

2EHA: 2-ethylhexyl acrylate
BA: n-butyl acrylate
MMA: methyl methacrylate
HEA: 2-hydroxyethyl acrylate
MAC: methacrylic acid
AAc: acrylic acid

### «Cyclic Oligosaccharide»

α-CD: α-cyclodextrin
γ-CD: γ-cyclodextrin
CI-mix: material mainly composed of cyclodextran
   (available from Nissin Sugar Manufacturing Co., Ltd., product name “CI-mix”)

### «Form of Main Agent»

Em: emulsion type
Sol: solvent type

### (3) Manufacture of Pressure Sensitive Adhesive Sheet

The coating solution of the emulsion-type acrylic-based pressure sensitive adhesive obtained in step (2) was applied with a coater to the release-treated surface of a tight release sheet R1 in which one surface of a polyethylene terephthalate film was subjected to release treatment with a silicone-based release agent. The coating solution was then heated at 90° C. for 1 minute to form a coating layer. Subsequently, the coating layer on the release sheet R1 obtained as above and an easy release sheet R2 obtained by release-treating one surface of a polyethylene terephthalate film with a silicone-based release agent were bonded together so that the release-treated surface of the release sheet R2 was in contact with the coating layer, to produce a pressure sensitive adhesive sheet having a pressure sensitive adhesive layer with a thickness of 25 μm, i.e., a pressure sensitive adhesive sheet having a configuration of release sheet R1/pressure sensitive adhesive layer (thickness: 25 um)/release sheet R2.

The thickness of the above pressure sensitive adhesive layer is a value measured using a constant-pressure thickness meter (available from TECLOCK Co., Ltd., product name “PG-02”) according to JIS K7130. In addition, it was confirmed that the release force for the release sheet R1 in the obtained pressure sensitive adhesive sheet was greater than that for the release sheet R2.

### Examples 2 to 4 and Comparative Examples 1 and 2

Pressure sensitive adhesive sheets were manufactured in the same manner as in Example 1 except that the type and ratio of monomers constituting the (meth)acrylate polymer and the type and compounding amount of cyclic oligosaccharide were as listed in Table 1.

In Comparative Example 2, an epoxy-based crosslinker (available from Nagase ChemteX Corporation, product name “Denacol EX-313”) was compounded as a crosslinker in an amount listed in Table 1. In Comparative Example 2, an aging period of 7 days was provided.

The particle size distribution (average particle diameter (D50)) of the emulsion-type (meth)acrylate polymer manufactured in each of Examples 2 to 4 and Comparative Examples 1 and 2 was measured in the same manner as in Example 1. The results are listed in Table 1.

### Reference Example

A solvent-type (meth)acrylate polymer was manufactured by copolymerizing 70 mass parts of 2-ethylhexyl acrylate, 15 mass parts of methyl methacrylate, and 15 mass parts of 2-hydroxyethyl acrylate using a solution polymerization method.

The coating solution of a solvent-type acrylic-based pressure sensitive adhesive was obtained through mixing and sufficiently stirring 100 mass parts of the solvent-type (meth)acrylate polymer obtained above and 5 mass parts of α-cyclodextrin (x-CD). In the solvent-type acrylic-based pressure sensitive adhesive, however, the solvent-type (meth)acrylate polymer and the α-cyclodextrin were not compatible with each other. As such, coating was not possible, and a pressure sensitive adhesive layer was not able to be formed.

### <Testing Example 1> (Measurement of Gel Fraction)

The pressure sensitive adhesive sheet manufactured in each of Examples and Comparative Examples was cut into a size of 80 mm×80 mm, the pressure sensitive adhesive layer was wrapped in a polyester mesh (mesh size of 200), the mass was weighed with a precision balance, and the mass of the pressure sensitive adhesive alone was calculated by subtracting the mass of the above mesh itself. The mass at that time is M1.

Then, the pressure sensitive adhesive wrapped in the above polyester mesh was immersed in ethyl acetate at room temperature (23° C.) for 72 hours. After that, the pressure sensitive adhesive was taken out, air-dried under an environment of a temperature of 23° C. and a relative humidity of 50% for 24 hours, and further dried in an oven at 80° C. for 12 hours. After the drying, the mass was weighed with a precision balance, and the mass of the pressure sensitive adhesive alone was calculated by subtracting the mass of the mesh itself. The mass at that time is M2. The gel fraction (%) is represented by (M2/M1)×100. Through this operation, the gel fraction of the pressure sensitive adhesive was derived. The results are listed in Table 2.

### <Testing Example 2> (Measurement of Adhesive Strength)

The release sheet R2 was removed from the pressure sensitive adhesive sheet manufactured in each of Examples and Comparative Examples, and the exposed pressure sensitive adhesive layer was bonded to the easy-adhesion layer of a polyethylene terephthalate (PET) film having the easy-adhesion layer (available from TOYOBO CO., LTD., product name “COSMOSHINE A4360,” thickness: 100 μm) to obtain a laminate of release sheet R1/pressure sensitive adhesive layer/PET film. The obtained laminate was cut into a width of 25 mm and a length of 100 mm.

The release sheet R1 was removed from the above laminate under an environment of 23° C. and 50% RH, and the exposed pressure sensitive adhesive layer was attached to a soda-lime glass plate (thickness: 1.1 mm) and then pressurized in an autoclave available from KURIHARA SEISAKUSHO Co., Ltd. at 0.5 MPa and 50° C. for 20 minutes. After that, it was left untouched under conditions of 23° C. and 50% RH for 24 hours, and then the adhesive strength (N/25 mm) when the laminate of the PET film and pressure sensitive adhesive layer was peeled off from the adherend was measured under a condition of a peel speed of 300 mm/min and a peel angle of 180° using a tensile tester (available from ORIENTEC Co., LTD., product name “TENSILON”). The measurement was conducted according to JIS Z0237: 2009 except for the condition described herein. The results are listed in Table 2.

### <Testing Example 3> (Measurement of Haze Value)

Each of the pressure sensitive adhesive layers of the pressure sensitive adhesive sheets manufactured in Examples and Comparative Examples was bonded to glass, and this was used as a sample for measurement. For the above sample for measurement, after background measurement was performed on glass, the haze value (%) was measured according to JIS K7136: 2000 using a haze meter (available from NIPPON DENSHOKU INDUSTRIES CO., LTD., product name “NDH-7000”). The results are listed in Table 2.

### <Testing Example 4> (Measurement of Total Luminous Transmittance)

Each of the pressure sensitive adhesive layers of the pressure sensitive adhesive sheets manufactured in Examples and Comparative Examples was bonded to glass, and this was used as a sample for measurement. For the above sample for measurement, after background measurement was performed on glass, the total luminous transmittance (%) was measured according to JIS K7361-1:1997 using a haze meter (available from NIPPON DENSHOKU INDUSTRIES CO., LTD., product name “SND-7000”). The results are listed in Table 2.

### <Testing Example 5> (Measurement of L*a*b*)

For the pressure sensitive adhesive sheet (with the release sheet removed) manufactured in each of Examples and Comparative Examples, the chromaticity a* and chromaticity b* as defined by the CIE 1976 L*a*b* color system were measured using a simultaneous photometric colorimeter (available from NIPPON DENSHOKU INDUSTRIES CO., LTD., product name “SQ2000”) according to JIS K7136: 2000. The results are listed in Table 2.

### <Testing Example 6> (Tensile Test)

After laminating a plurality of pressure sensitive adhesive layers of the pressure sensitive adhesive sheet manufactured in each of Examples and Comparative Examples to a total thickness of 600 μm, a sample of 10 mm width×75 mm length was cut out. The above sample was set in a tensile tester (available from ORIENTEC Co., LTD., product name “TENSILON”) so as to have a sample measurement site of 10 mm width×25 mm length (stretching direction) and stretched at a tensile speed of 200 mm/min under an environment of 23° C. and 50% RH using the tensile tester. The above sample was stretched until it broke, and the maximum stress (N/mm²) and breaking energy (MJ/m³) at that time were measured. In addition, the tensile elastic modulus (MPa) was measured by the above tensile test. The results are listed in Table 2.

### <Testing Example 7> (Measurement of Holding Power)

The holding power of the pressure sensitive adhesive sheet was measured according to JIS Z0237: 2009 except for the operation described below. The pressure sensitive adhesive sheet manufactured in each of Examples and Comparative Examples was cut to a size of 25 mm×125 mm, the release sheet R2 was removed, and only the pressure sensitive adhesive layer of the above pressure sensitive adhesive sheet of 25 mm×25 mm was attached to a stainless steel plate (SUS 304 #360). The stainless steel plate was then disposed vertically to the ground so that the above pressure sensitive adhesive sheet was suspended from the stainless steel plate, and left untouched at 40° C. for 15 minutes. After that, the pressure sensitive adhesive sheet was left untouched at 40° C. for 24 hours while applying a load of 1 kg, and the amount of displacement (μm) of the pressure sensitive adhesive sheet after 70,000 seconds was measured. The results are listed in Table 2.

### <Testing Example 8> (Evaluation of Pressure Sensitive Adhesive Durability)

The release sheet R2 was removed from the pressure sensitive adhesive sheet manufactured in each of Examples and Comparative Examples, and the exposed pressure sensitive adhesive layer was bonded to the easy-adhesion layer of a PET film having the easy-adhesion layer (available from TOYOBO co., LTD., product name “COSMOSHINE A4360,” thickness: 100 μm) to obtain a laminate of release sheet R1/pressure sensitive adhesive layer/PET film. The obtained laminate was cut into a width of 50 mm and a length of 100 mm.

The release sheet R1 was removed from the above laminate under an environment of 23° C. and 50% RH, and the exposed pressure sensitive adhesive layer was attached to a soda-lime glass plate (thickness: 1.1 mm), which was then Subsequently, 2 cm of the top end of installed vertically. the pressure sensitive adhesive sheet was peeled off, and a hole was made with a punch. A load of 1 kg was suspended from a string passed through that hole, and the behavior of the pressure sensitive adhesive sheet peeling off from the soda-lime glass plate was observed. Then, the pressure sensitive adhesive durability was evaluated based on the following criteria. The results are listed in Table 2.
◯: The peeled end portion did not move until 1 minute.
×: Peeling progressed within 1 minute.

### <Testing Example 9> (Evaluation of Bending Durability)

Under an environment of 23° C. and 50% RH, the release sheet R2 was removed from the pressure sensitive adhesive sheet produced in each of Examples and Comparative Examples, and the exposed pressure sensitive adhesive layer was bonded to the easy-adhesion layer of a PET film having the easy-adhesion layer (available from TOYOBO CO., LTD., product name “COSMOSHINE A4360,” thickness: 100 μm) as the base material. Subsequently, the release sheet R1 was removed, and the exposed pressure sensitive adhesive layer was bonded to the PET film as the base material in the same manner as above. Then, they were pressurized in an autoclave available from KURIHARA SEISAKUSHO Co., Ltd. at 0.5 MPa and 50° C. for 20 minutes, and thereafter left untouched for 24 hours under a condition of 23° C. and 50% RH. The laminate composed of PET film (base material)/pressure sensitive adhesive layer/PET film (base material) thus obtained was cut into 150 mm×50 mm, and this was used as a sample.

The obtained sample was bent 100,000 times under an environment of 23° C. and 50% RH and at a bending diameter of 3 mmφ, a stroke of 80 mm, and a bending speed of 30 rpm. After that, the longitudinal end portions of the sample were observed with a digital microscope, the amount of displacement relative to the base material was measured at each of both end portions of the pressure sensitive adhesive layer, and the end portion dimensional change ratio (%) of the pressure sensitive adhesive layer relative to the base material length was calculated based on the total value of the amounts of displacements of both ends. In addition, the floating/delamination of the bent portion of the sample was visually confirmed. Then, the bending durability (including the concept of pressure sensitive adhesive durability) was evaluated based on the following criteria. The results are listed in Table 2.

◯: No floating/delamination was observed at the bent portion and the end portion dimensional change ratio was within 5%.
Δ: No floating/delamination was observed at the bent portion and the end portion dimensional change ratio was more than 5%, or floating was observed at the bent portion and the end portion dimensional change ratio was within 5%.
×: Delamination was observed at the bent portion and the end portion dimensional change ratio was more than 5%.

TABLE 1

| | (Meth)acrylate polymer | | | | | | | | | | |
|---|---|---|---|---|---|---|---|---|---|---|---|
| | Composition | | | | | | D50 | Form of | Cyclic oligosaccharide | | Crosslinker |
| | 2EHA | BA | MMA | HEA | MAc | AAc | nm | main agent | Type | mass parts | mass parts |
| Example 1 | 82 | — | 15 | — | 2 | 1 | 150 | Em | α-CD | 5 | — |
| Example 2 | 82 | — | 15 | — | 2 | 1 | 150 | Em | | 10 | — |
| Example 3 | 82 | — | 15 | — | 2 | 1 | 150 | Em | γ-CD | 5 | — |
| Example 4 | 75 | 7 | 15 | — | 2 | 1 | 150 | Em | Cl-mix | 5 | — |
| Comparative Example 1 | 82 | — | 15 | — | 2 | 1 | 150 | Em | — | — | — |
| Comparative Example 2 | 82 | — | 15 | — | 2 | 1 | 150 | Em | — | — | 1 |
| Reference Example | 70 | — | 15 | 15 | — | — | — | Sol | α-CD | 5 | — |

TABLE 2

| | | | | Total | | | | | Tensile | Holding power | Pressure | |
|---|---|---|---|---|---|---|---|---|---|---|---|---|
| | Gel | Adhesive | Haze | luminous | | | Maximum | Breaking | elastic | (amount of | sensitive | |
| | fraction | strength | value | transmittance | | | stress | energy | modulus | displacement) | adhesive | Bending |
| | % | N/25 mm | % | % | a* | b* | N/mm² | MJ/m³ | MPa | μm | durability | durability |
| Example 1 | 78 | 10.7 | 0.7 | 91.4 | −0.2 | 0.3 | 16.4 | 94.5 | 2.0 | 50 | ∘ | ∘ |
| Example 2 | 76 | 7.7 | 1.7 | 91.1 | −0.2 | 0.4 | 18.7 | 128.5 | 11.1 | 33 | ∘ | ∘ |
| Example 3 | 74 | 12.8 | 0.3 | 91.5 | −0.3 | 0.4 | 14.0 | 63.5 | 0.6 | 58 | ∘ | ∘ |
| Example 4 | 74 | 13.1 | 0.5 | 91.1 | −0.3 | 0.6 | 15.4 | 90.1 | 0.6 | 66 | ∘ | ∘ |
| Comparative | 88 | 10.9 | 0.2 | 91.6 | −0.3 | 0.2 | 8.0 | 20.4 | 0.6 | 102 | ∘ | x |
| Example 1 | | | | | | | | | | | | |
| Comparative | 80 | 2.9 | 0.6 | 91.7 | −0.3 | 0.2 | 12.4 | 11.3 | 2.2 | 31 | x | x |
| Example 2 | | | | | | | | | | | | |

| | |
|---|---|
| Reference | Coating was not possible due to incompatibility |
| Example | |

As found from Table 2, the pressure sensitive adhesive sheets obtained in the examples were excellent in the pressure sensitive adhesive durability (including bending durability) and holding power.

### INDUSTRIAL APPLICABILITY

The pressure sensitive adhesive sheet of the present invention can be used for various applications, including optical applications, and can be used suitably in devices that are repeatedly bent.

### DESCRIPTION OF REFERENCE NUMERALS

1A, 1B . . . Pressure sensitive adhesive sheet
11 . . . . Pressure sensitive adhesive layer
12, 12a, 12b . . . . Release sheet
13 . . . . Base material

1. A pressure sensitive adhesive sheet comprising at least a pressure sensitive adhesive layer, wherein
a pressure sensitive adhesive constituting the pressure sensitive adhesive layer is an emulsion-type pressure sensitive adhesive containing a cyclic oligosaccharide, and
an adhesive strength to soda-lime glass is 5 N/25 mm or more.

2. The pressure sensitive adhesive sheet according to claim 1, wherein a holding power according to JIS Z0237: 2009 is less than 100 μm as an amount of displacement after 70,000 seconds, wherein the amount of displacement is measured when an attachment area is 25 mm×25 mm, a test temperature is 40° C., a leaving time is 24 hours, and a load is 1 kg.

3. The pressure sensitive adhesive sheet according to claim 1, wherein, provided that the pressure sensitive adhesive layer has a thickness of 600 μm and a width of 10 mm, a maximum stress when stretched to a breaking elongation at a measurement length of 20 mm and a tensile speed of 200 mm/min under an environment of 23° C. and 50% RH is 9 N/mm² or more.

4. The pressure sensitive adhesive sheet according to claim 1, wherein, provided that the pressure sensitive adhesive layer has a thickness of 600 μm and a width of 10 mm, a breaking energy when stretched to a breaking elongation at a measurement length of 20 mm and a tensile speed of 200 mm/min under an environment of 23° C. and 50% RH is 30 MJ/m³ or more.

5. The pressure sensitive adhesive sheet according to claim 1, wherein the emulsion-type pressure sensitive adhesive is an emulsion-type acrylic-based pressure sensitive adhesive.

6. The pressure sensitive adhesive sheet according to claim 1, comprising a base material and the pressure sensitive adhesive layer.

7. The pressure sensitive adhesive sheet according to claim 1, comprising:
two release sheets; and
the pressure sensitive adhesive layer interposed between the two release sheets so as to be in contact with release surfaces of the two release sheets.

8. A method for manufacturing the pressure sensitive adhesive sheet according to claim 5, comprising:
subjecting an acrylic-based monomer containing an alkyl (meth)acrylate ester to emulsion polymerization under a presence of an emulsifier to manufacture an emulsion-type (meth)acrylate polymer;
preparing an emulsion-type acrylic-based pressure sensitive adhesive containing the emulsion-type (meth)acrylate polymer and a cyclic oligosaccharide; and
applying the emulsion-type acrylic-based pressure sensitive adhesive to form the pressure sensitive adhesive layer.

9. The method for manufacturing the pressure sensitive adhesive sheet according to claim 8, wherein an average particle diameter of the emulsion-type (meth)acrylate polymer is 50 nm or more and 300 nm or less.
